(19) United States
(12) Patent Application Publication
(10) Pub. No.: US 2009/0055386 A1
(43) Pub. Date: Feb. 26, 2009

(54) System and Method for Enhanced In-Document Searching for Text Applications in a Data Processing System

(76) Inventors: Gregory J. Boss, American Fork, UT (US); Rick A. Hamilton, II, Charlottesville, VA (US); Brian M. O'Connell, Cary, NC (US); Keith R. Walker, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/844,911

(22) Filed: Aug. 24, 2007

(51) Int. Cl. G06F 17/30; G06F 7/10

(52) U.S. Cl. 707/5; 707/E17.017

(57) ABSTRACT

A system and method for implementing enhanced searching within a document in a data processing system. A search manager receives an original search term, wherein the original search term includes at least two words. The search manager creates a set of alternate search terms by: retrieving from a predetermined thesaurus database at least one synonym for at least one word in the original search term; and inserting at least on wildcard between the at least two words within the original search term. The search manager performs at least one search utilizing the set of alternate search terms and the original search term. The search manager ranks the search results from the at least one search according to a predetermined priority order. The search manager outputs the ranked search results.

### BACKGROUND OF THE INVENTION

1. Technical Field

The present invention relates in general to the field of data processing systems and in particular, the present invention relates to the field of processing data on data processing systems. Still more particularly, the present invention relates to searching data on data processing systems.

2. Description of the Related Art

As data processing systems become more prevalent in the workplace, more and more documents are stored in electronic format to aid in the portability and the searching of these documents. To assist users in locating a particular document or passage, some search programs on data processing systems may enable a user to enter keywords and return all documents or passages that include the entered keywords. [None of the following change is important—just some more details of related art if you would like to expand this section a bit.] In more advanced search programs on data processing systems, a user may enter regular expressions, wildcards, or other similar syntax to allow more granular control over a search than keywords. For example, a user may search with a regular expression of “Week ([0-9]+)” to find in a document all occurrences of a numeric week number, such as the “23” in “Week 23.” While such advanced search programs on data processing systems enable a user to perform more capable searches, there are drawbacks. One drawback is the specialized syntax may not be known by most users, thereby not providing benefit to most users. Another drawback is even experts of the syntax may include errors in their searches, which they may not realize because rather than an error message returned, the search may return no results, fewer results than needed, more results than needed, or a different set of results than needed.

### SUMMARY OF THE INVENTION

The present invention includes a system and method for implementing enhanced searching within a document in a data processing system. A search manager receives an original search term, wherein the original search term includes at least two words. The search manager creates a set of alternate search terms by: retrieving from a predetermined thesaurus database at least one synonym for at least one word in the original search term; and inserting at least on wildcard between the at least two words within the original search term. The search manager performs at least one search utilizing the set of alternate search terms and the original search term. The search manager ranks the search results from the at least one search according to a predetermined priority order. The search manager outputs the ranked search results.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which an embodiment of the present invention may be implemented;

FIG. 2 is a block diagram depicting an exemplary data processing system in which an embodiment of the present invention may be implemented; and

FIG. 3 is a high-level flowchart illustrating an exemplary method for enhanced in-document searching for text applications in a data processing system according to an embodiment of the present invention.

### DETAILED DESCRIPTION OF AN EMBODIMENT

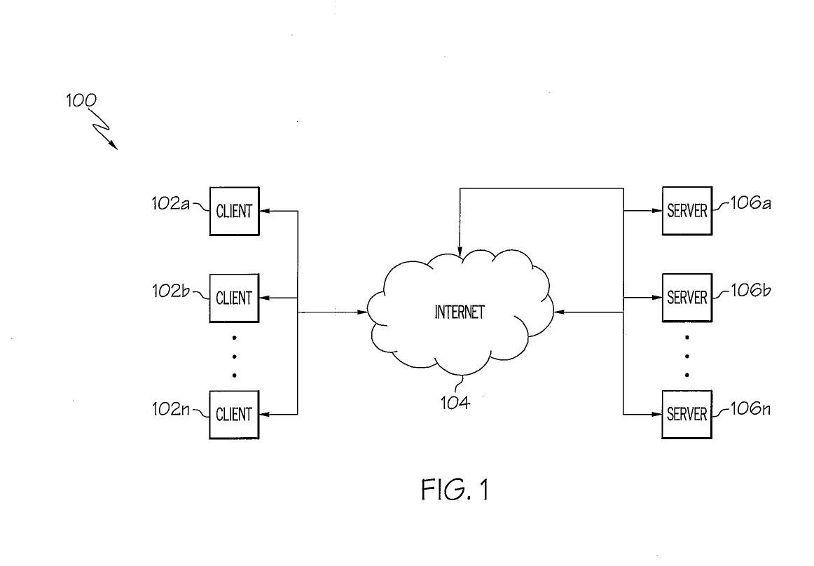

Referring now to the figures, and in particular, referring to FIG. 1, there is illustrated an exemplary network 100 in which an embodiment of the present invention may be implemented. As illustrated, exemplary network 100 includes a collection of clients 102a-102n, Internet 104, and servers 106a-106n.

According to an embodiment of the present invention, servers 106a-106n may act as file servers that store content that may include, but are not limited to text documents, images, and video files, and the like. Clients 102a-102n issue requests for access to content stored on servers 106a-106n via Internet 104.

Clients 102a-102n are coupled to servers 106a-106n via Internet 104. While Internet 104 is utilized to couple clients 102a-102n to servers 106a-106n, those with skill in the art will appreciate that a local-area network (LAN) or wide-area network (WAN) utilizing Ethernet, IEEE 802.11x, or any other communications protocol may be utilized. Those with skill in the art will appreciate that exemplary network 100 may include other components such as routers, firewalls, etc. that are not germane to the discussion of the present network and will not be discussed further herein.

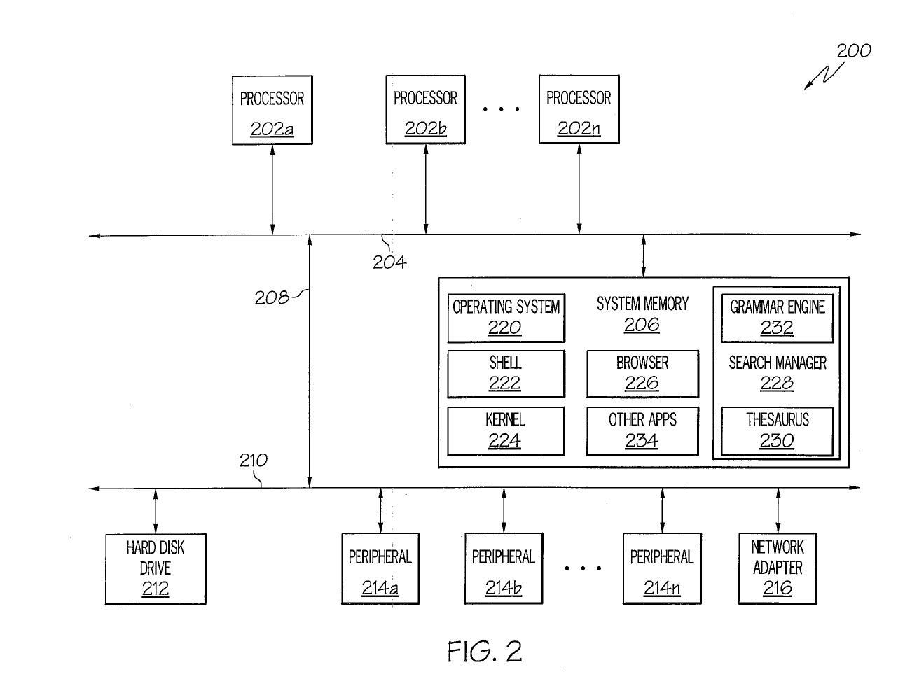

FIG. 2 is a block diagram depicting an exemplary data processing system 200, which may be utilized to implement clients 102a-102n and servers 106a-106n as shown in FIG. 1, in accordance with an embodiment of the present invention. As shown, exemplary data processing system 200 includes a collection of processors 202a-202n that are coupled to a system memory 206 via system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-21n, which may include, but are not limited to optical drives, other hard disk drives, printers, input devices, and the like. Also coupled to peripheral bus 210 is a network adapter 216, which enables data processing system 200 to communicate with a network (e.g., Internet 104, a LAN, a WAN, and the like).

Also, as depicted, system memory 106 includes an operating system 220, which further includes a shell 222 (as it is called in UNIX®) for providing transparent user access to resources such as browser 226 (utilized for access to Internet 104) and other applications 234. Other applications 234 may include word processors, spreadsheets, databases, and the like. Generally, shell 222, also called command processors in Microsoft® Windows®, is generally the highest level of the operating system software hierarchy and serves as a command interpreter. Shell 222 provide system prompts, interpret commands entered by keyboard, mouse, or other user input media, and sends the interpreted command(s) to the appropriate lower levels of the operating system (e.g., kernel 224) for processing. Note that while shell 222 is a text-based, line-oriented user interface, the present invention will support other user interface modes, such as graphical, voice, gestural, etc. equally well.

As illustrated, operating system 220 also includes kernel 224, which further includes lower levels of functionality for operating system 220, browser 226, and other applications 234, including memory management, process and task management, disk management, and mouse and keyboard management.

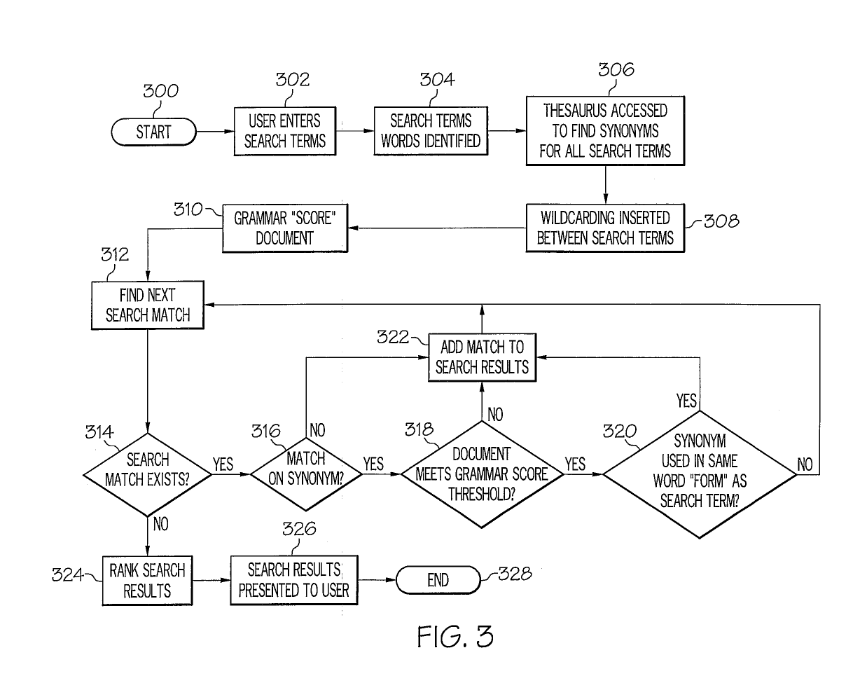

System memory 206 also includes a search manager 228, which further includes a thesaurus 230, and a grammar engine 232. Search manager 228, in conjunction with thesaurus 230 and grammar engine 232, enables a user to perform enhanced searches within documents (or other content) retrieved from servers 106a-106n (FIG. 1) via Internet 104 (FIG. 1). The operation of search manager 228, thesaurus 230, and grammar engine 232 will be discussed herein in more detail in conjunction with FIG. 3.

Those with skill in the art will appreciate that data processing system 200 can include many additional components not specifically illustrated in FIG. 2. Because such additional components are not necessary for an understanding of the present invention, they are not illustrated in FIG. 2 or discussed further herein. It should be understood that the enhancements to data processing system 200 provided by the present invention are applicable to data processing systems of any system architecture and are in no way limited to the generalized multi-processor architecture depicted in FIG. 2.

The present invention includes a method to enhance document searching on a data processing system. Those with skill in the art will appreciate that the present invention applies to all types of documents including, but not limited to, speech-to-text translations, native documents, etc.

### “Wildcarding”

An embodiment of the present invention includes “wildcarding”, which means that any number of characters/spaces/or other text may be present between user-entered search terms. To maximize the accuracy of the search, an embodiment of the present invention limits the number of words the wildcard will match between search terms. Additionally, for each search term entered, thesaurus 230 is utilized to substitute the search terms with synonyms. Also, grammar engine 232 is optionally referenced to refine the number of results returned by the search results.

In the simplest form, wildcards can be set to a default length. However, several methods are may be implemented to adjust the wildcard length to achieve and optimum search result set.

1-to-X Incrementing

An embodiment of the present invention involves starting with no wildcards and evaluating the number of search results returned. If the number of returned results is below a user-defined threshold, then another search will be performed utilizing one wildcard. If the result set is still below a user-defined threshold, the wildcard count will increase by one until the user-defined threshold is met. A user may, for example, want at least 100 results ordered by relevancy. In one example, a user may enter a search term that includes “[word1][word2]”. The search may only return 3 results. Search manager 228 will place the 3 results at the top of the results list and then perform a search for “[word1][word2]”, where “*” represents a single word wildcard. In an embodiment of the present invention, each wildcard character represents a single word. If 15 results are found in the second search, search manager 228 would add the 15 results to the original 3 results. Subsequently, search manager 228 would perform a search for “[word1]**[word2]” and continue adding wildcards until the threshold of 100 results has been retrieved. Incrementing the number of wildcards would cease as soon as a zero result set or a result set number equaling the previously searched set was retrieved.

1-to-X Incrementing with Replacement

Another embodiment of the present invention includes 1-to-X incrementing wildcards with word replacement. Thesaurus 230 examines the words in the search terms and in subsequent searches, replaces the original words to generate a greater number of results. The operation of thesaurus 230 will be discussed herein in more detail.

A sample search series may include the following:

1. [word1][word2]

2. [word1]*[word2]

3. [word1replacement1]*[word2replacement1]

4. [word1]**[word2]

5. [word1replacement]**[word2replacement]

6. [word1]***[word2]

7. [word1replacement2]***[word2replacement2]

8. [word1]****[word2]

Note that at step 3, the first thesaurus replacement word is introduced for both word1 and word2. Also, note that at step 7, a second replacement word is introduced for both word1 and word2. Alternatively, the replacement of thesaurus synonyms can occur at a faster or slower rate than the wildcard increment.

### Historical Log Augmentation

In another embodiment of the present invention, historical log augmentation enables search manager 228 to evaluate previous search results that utilize 1-to-X incrementing, 1-to-X incrementing with replacement, and thesaurus and grammar strategies to determine which strategy is the most effective. The evaluation of the strategies may be performed by determining which of the search result sets were visited or viewed for a significant amount of time (determined by a default or user-enabled setting). For example (and not for limitation purposes) search manager 228 may determine that a user consistently utilizes the term “goalie”, but actually views a majority of search results that were retrieved utilizing the replacement term “goaltender”. Search manager 228 may order future search results that place results that include the term “goaltender” nearer to the top of the search results list.

### Thesaurus Replacement

Thesaurus 230 may replace search terms with synonyms to provide more relevant search results to the user. As well known to those with skill in the art, thesaurus dictionaries order synonyms by relevancy. A thesaurus replacement strategy would favor search result sets that include the unaltered search terms as entered by the user. In the event that either no search results exist or few results exist, replacement terms as defined by thesaurus 230 would then be substituted to generate more search results. When utilizing thesaurus replacement combined with wildcarding, the search results utilizing most of the original terms may be presented nearer to the top of the search results list. The precedence of original search terms is followed by the lower precedence of thesaurus terms ordered by relevancy. For example, if the term “goalie” is entered and thesaurus 230 indicates that potential replacements include “goalkeeper”, “goaltender”, and “netkeeper”, as listed in order of relevancy, the search results utilizing “goalie” would take precedence. Precedence, as previously discussed, is illustrated by presenting search results with higher precedence nearer to the top of the search results list as compared to search results with lower precedence. If no results, or few results, are found with “goalie”, subsequent searches may be performed by search manager 228 utilizing the terms “goalkeeper”, “goaltender”, and “netkeeper”.

FIG. 3 is a high-level logical flowchart illustrating an exemplary method for implementing an enhanced search in a data processing system according to an embodiment of the present invention. For example, for the purpose of discussion and not limitation, assume that a client (e.g., client 102a) has retrieved a lengthy document from one of servers 106a-106n.

The process begins at step 300 and continues to step 302, which illustrates a user entering search terms (“Johnson gain”) that are received by search manager 228. The process continues to step 304, which depicts search manager 228 identifying the words in the entered search terms. The process proceeds to step 306, which illustrates thesaurus 230 accessed by search manager 228 to find synonyms of all entered search terms. For example, some synonyms of “gain” might be “increase”, “accumulation”, “advantage”, etc. For the purposes of discussion, the character “|” is utilized to represent a Boolean “OR” operator. The search term, after accessing thesaurus 230 may appear as: “[Johnson][gain|increase|accumulation|advantage]”. The process proceeds to step 308, which shows search manager 308 inserting wildcards between search terms to expand the scope of the search, if necessary. For example, assume that a default or user-defined threshold for wildcards between search terms is three. For the purposes of discussion, the character “*” is utilized to represent a wildcard. The search term, after wildcarding may appear as “[Johnson]***[gain|increase|accumulation|advantage]”.

The process continues to step 310, which illustrates grammar engine 232 scoring the document or text being searched. Grammar engine 232 generates at least one grammar score or readability statistic regarding the document or text being searched. According to an embodiment of the present invention, any grammar scoring strategy may be employed including, but not limited to the Bormuth readability score, the Coleman-Liau readability score, and the Flesch-Kincaid readability score. If the generated grammar score or readability statistic indicates that the document or text being searched includes poor grammar (relative to mainstream use) or technical grammar, a different type of thesaurus (e.g., a technical thesaurus) may be utilized in step 306.

The process proceeds to step 312, which depicts search manager 228 finding the next match within the document or text under search by the search string generated at step 308. The process continues to step 314, which illustrates search manager 228 determining if a match exists. If search manager 228 determines that a match exists, the process continues to step 316, which illustrates search manager 228 determining if the match was a match on a synonym or an originally-entered search term.

If the match was not a match on a synonym, the process continues to step 322, which illustrates search manager 228 adding the match to the search results. If the match was a match on a synonym, the process continues to step 318, which shows search manager 228 determining if the document or text under search meets a minimum grammar score threshold. If the document or text under search does not meet a minimum grammar score threshold, the process continues to step 322, which shows search manager 228 adding the match to the search results.

If the document or text under search meets a minimum grammar score threshold, the process continues to step 320, which depicts search manager 228 determining if the synonym utilized is in the same form as one of the possible forms of the initial search term. For example, suppose the initial search term is only a noun and verb form, but the synonym located in the document is in an adjective form. This is considered an invalid match, and the search result is discarded. Hence, if the synonym utilized is not in the same form as one of the possible forms of the initial search term, the process returns to step 312. However, if the synonym is in the same form as one of the possible forms of the initial search term, the process proceeds to step 322, which illustrates search manager 228 adding the match to the search results. The process returns to step 312.

Returning to step 314, if a search match does not exist, the process continues to step 324, which shows search manager 228 ranking the search results from high precedence to low precedence utilizing the following criteria:
1. Exact match;
2. Matches with implied wildcarding between terms. Matches with fewer words between terms are favored over more words between terms;
3. Matches with synonyms. Matches with one synonym substituted are favored over matches with more synonyms substituted; and
4. Matches with both synonyms and wildcarding, which are ranked from the least number of synonyms and fewer words between terms to n number of synonyms and the most words between terms.

The process continues to step 326, which illustrates search manager 228 presenting the results to the user. In an embodiment of the present invention, the results may be presented or outputted to a display coupled to peripheral bus 210 (FIG. 1) or maybe sent to a printer, memory device, or any type of non-removable or removable storage. The process then ends, as illustrated in step 328.

As discussed, the present invention includes a system and method for implementing enhanced searching within a document in a data processing system. A search manager receives an original search term, wherein the original search term includes at least two words. The search manager creates a set of alternate search terms by: retrieving from a predetermined thesaurus database at least one synonym for at least one word in the original search term; and inserting at least on wildcard between the at least two words within the original search term. The search manager performs at least one search utilizing the set of alternate search terms and the original search term. The search manager ranks the search results from the at least one search according to a predetermined priority order. The search manager outputs the ranked search results.

It should be understood that at least some aspects of the present invention may alternatively be implemented as a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for implementing enhanced searching within a document in a data processing system, said computer-implementable method comprising:
receiving an original search term, wherein said original search term includes at least two words;
creating a set of alternate search terms, wherein said creating further includes:
retrieving from a predetermined thesaurus database at least one synonym for at least one word in said original search term; and
inserting at least one wildcard between said at least two words within said original search term;
performing at least one search utilizing said set of alternate search terms and said original search term;
ranking search results from said at least one search according to a predetermined priority order; and
outputting said ranked search results.

2. The computer-implementable method according to claim 1, further comprising:
generating a readability score from said document;
in response to generating said readability score, selecting an alternate predetermined thesaurus database.

3. The computer-implementable method according to claim 1, wherein said ranking search results further comprises:
ranking search results from high precedence to low precedence according to the following sequence:
search results based on said original search term that generates an exact match;
search results based on at least one alternate search term that includes at least one wildcard;
searches results based on at least one alternate search term that includes at least one synonym; and
search results based on at least one alternate search term that includes both at least one wildcard and at least one synonym.

4. A system for implementing enhanced searching within a document in a data processing system, said system comprising:
at least one processor;
a databus coupled to said at least one processor;
a computer-usable medium embodying computer program code, said computer program code comprising instructions executable by said at least one processor and configured for:
receiving an original search term, wherein said original search term includes at least two words;
creating a set of alternate search terms, wherein said creating further includes:
retrieving from a predetermined thesaurus database at least one synonym for at least one word in said original search term; and
inserting at least one wildcard between said at least two words within said original search term;
performing at least one search utilizing said set of alternate search terms and said original search term;
ranking search results from said at least one search according to a predetermined priority order; and
outputting said ranked search results.

5. The system according to claim 4, wherein said computer program code further comprises instructions configured for:
generating a readability score from said document;
in response to generating said readability score, selecting an alternate predetermined thesaurus database.

6. The system according to claim 4, wherein said computer program code including instructions configured for ranking search results further includes instructions configured for:
ranking search results from high precedence to low precedence according to the following sequence:
search results based on said original search term that generates an exact match;
search results based on at least one alternate search term that includes at least one wildcard;
searches results based on at least one alternate search term that includes at least one synonym; and
search results based on at least one alternate search term that includes both at least one wildcard and at least one synonym.
